(19) United States
(12) Patent Application Publication
(10) Pub. No.: US 2009/0198722 A1
(43) Pub. Date: Aug. 6, 2009

(54) System and method for deriving the minimum number of bytes required to represent numeric data with different physical representations

(76) Inventors: Stephen Michael Hanson, Romsey (GB); Geoffrey Raymond Judd, Basingstoke (GB)

Correspondence Address: MAXVALUEIP CONSULTING LLC, 11204 ALBERMYRTLE ROAD, POTOMAC, MD, 20854, US

(21) Appl. No.: 12/024,026

(22) Filed: Jan. 31, 2008

(51) Int. Cl. G06F 17/30

(52) U.S. Cl. 707/102; 707/E17.044

(57) ABSTRACT

For individual data items described by XML Schema elements and attributes of simple type, the type definitions are capable of defining the range of numeric data. Once the range is known, it is possible to deduce the number of bytes required for a given physical representation (primitive or inherited). A method is provided (as an example) for determining the minimum number of bytes required for twos complement integer, packed decimal and extended decimal representations.

### BACKGROUND OF THE INVENTION

A frequent scenario is to take extensible markup language (XML) data described by an XML Schema and generate the equivalent data in a legacy format, such as a binary form. Given an XML Schema as the starting point, an embodiment of this invention describes a means of automatically deriving the minimum number of bytes required to represent numeric data with different physical representations. To do this manually is a time consuming and error prone process.

The XML 1.0 Second Edition specification defines limited facilities for applying datatypes to document content in that documents may contain or refer to DTDs that assign types to elements and attributes. However, document authors, including authors of traditional documents and those transporting data in XML, often require a higher degree of type checking to ensure robustness in document understanding and data interchange.

The limited datatyping facilities in XML have prevented validating XML processors from supplying the rigorous type checking required in these situations. The result has been that individual applications writers have had to implement type checking in an ad hoc manner. An embodiment of this invention addresses the need of both document authors and applications writers for a robust, extensible datatype system for XML which could be incorporated into XML processors.

### SUMMARY OF THE INVENTION

An XML Schema that describes some data provides the majority of logical information needed for any representation of that data, not just an XML representation. Looking at individual data items described by XML Schema elements and the attributes of simple type, the type definition is capable of defining the range of numeric data. Once the range is known, it is possible to deduce the number of bytes required for a given physical representation. This representation can be either part of the XML Schema, or it can be a custom built inherited representation. An embodiment of this invention provides a method for determining the minimum number of bytes required for twos complement integer, packed decimal and extended decimal representations.

### BRIEF DESCRIPTION OF THE DRAWINGS

FIG. 1 is a schematic diagram of the system.

FIG. 2 is a schematic diagram of different flow paths taken by the system with XML facets and custom built facets (inherited facets).

### DETAILED DESCRIPTION OF THE PREFERRED EMBODIMENTS

XML Schema provides a number of built-in simple types to model numeric data. An embodiment of this invention relates to the built-in simple types derived from xs:decimal. In the XML Schema model, the type derivation is achieved by applying XML Schema facets to a parent type. Further, users can derive their own custom simple types from built-in types, again using facets. An embodiment of his invention examines the facets on both built-in types (210) and custom types (212), and for a given physical representation determines the length of bytes needed to represent the data (114 or 214).

The facets of a datatype serve to distinguish those aspects of one datatype which differ from other datatypes. Rather than being defined solely in terms of a prose description, the datatypes in one embodiment are defined in terms of the synthesis of facet values which together determine the value space and properties of the datatype.

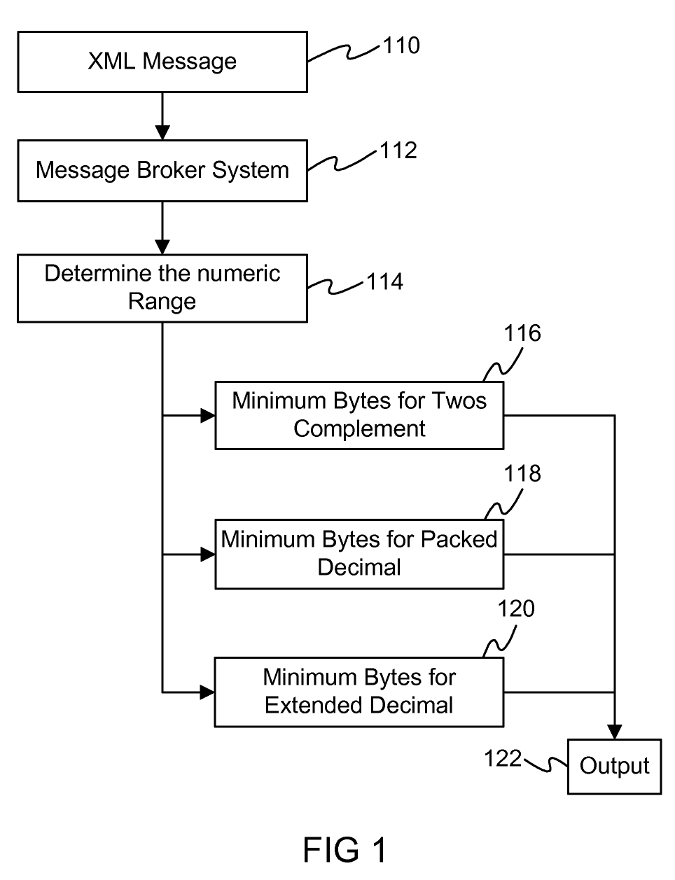

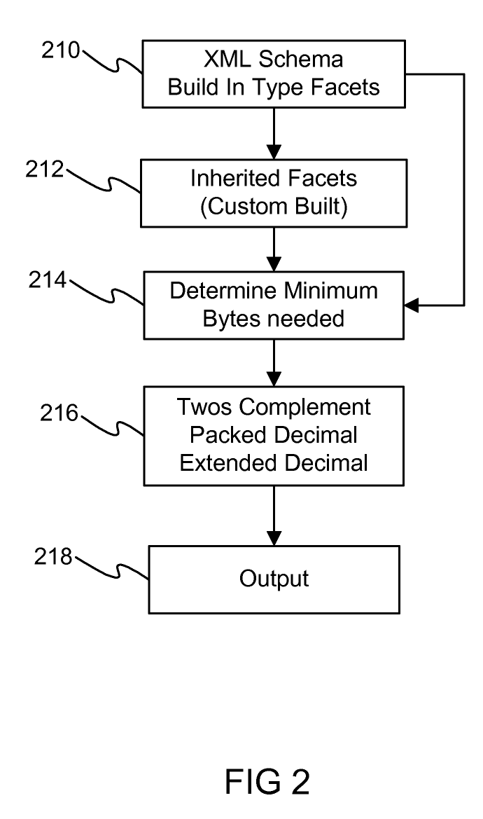

For example, FIG. 2 describes the derivation of facets from a primitive type, and the computation of the minimum number of bytes (214) from the constructed facet in the three separate formats (216) explained below. FIG. 1 illustrates an embodiment of this system.

For a complete list of built-in data types of the XML Schema specification, please refer to the following Web site (http://www.w3.org/TR/2004/REC-xmlschema-2-20041028/datatypes.html).

### Twos Complement Integer Representation

In one embodiment, if an xsd:TotalDigits facet is present, the value will be used to calculate the length. It is assumed that the integer is not signed in calculating the length. Table 1 shows the lengths defaulted for different values of xsd:TotalDigits.

TABLE 1

| xsd:TotalDigits Value | Length |
|---|---|
| <=2 | 1 |
| >2 && <=4 | 2 |
| >4 && <=9 | 4 |
| >9 | 8 |

In one embodiment, if there is no xsd:TotalDigits facet, then the xsd:Min/MaxExclusive/Inclusive facets will be used to determined the length but only if there are both a Min and Max facets specified. If the MinExclusive is less than −1 or the MinInclusive facet is less than or equal −1, the length will be determined based on a signed integer. Otherwise, the length will be determined based on an unsigned integer. Table 2 shows the length determined based on the maximum absolute value of the Min/Max values for signed integers.

TABLE 2

| xsd:Min/MaxExclusive/Inclusive | Length |
|---|---|
| <(=)128 | 1 |
| >(=)128 && <(=)32768 | 2 |
| >(=)32768 && <(=)2147483648 | 4 |
| >(=)2147483648 | 8 |

Table 3 shows the length determined based on the maximum absolute value of the Min/Max values for unsigned integers.

TABLE 3

| xsd:Min/MaxExclusive/Inclusive | Length |
|---|---|
| <(=)256 | 1 |
| >(=)256 && <(=)65536 | 2 |
| >(=)65536 && <(=)4294967295 | 4 |
| >(=)4294967295 | 8 |

### Packed Decimal Representation

In one embodiment, if an xsd:TotalDigits facet is present the value will be used to determine the length as shown in Table 4.

TABLE 4

| xsd:TotalDigits | Length |
|---|---|
| (xsd:TotalDigits + 1) % 2 == 0 | (xsd:TotalDigits + 1)/2 |
| (xsd:TotalDigits + 1) % 2 != 0 | ((xsd:TotalDigits + 1)/2) + 1 |

In one embodiment, if there is no xsd:TotalDigits facet then the xsd:Min/MaxExclusive/Inclusive facets will be used to determine the length but only if there are both a Min and Max facet specified. Any signs and decimal points are first removed from the textual representations of the facets. Then the maximum length of the resulting Min/Max values will be used as the basis for the length as shown in Table 5.

TABLE 5

| xsd:Min/MaxExclusive/Inclusive | Default Length |
|---|---|
| (maxLength + 1) % 2 == 0 | (maxLength + 1)/2 |
| (maxLength + 1) % 2 != 0 | ((maxLength + 1)/2) + 1 |

### Extended Decimal Representation

In one embodiment, if an xsd:TotalDigits facet is present the its value will be used as the length.

In one embodiment, if there is no xsd:TotalDigits facet then the xsd:Min/MaxExclusive/Inclusive facets will be used to determine the default length but only if there are both a Min and Max facet specified. Any signs and decimal points are first removed from the textual representations of the facets. Then, the maximum length of the resulting Min/Max values is used as the length.

One embodiment the invention describes a method of deriving the minimum number of bytes required to represent numeric data with different physical representations in a message broker system (112), the method comprising the steps of:

A message broker system receiving input data and input data type in an extensible markup language (110);
wherein the input data type has multiple facets and multiple attributes;
wherein the input data is represented with the input data type;
wherein the input data type comprises twos-complement-integer representation (116), packed-decimal representation (118), and extended-decimal representation (120);
wherein the multiple facets comprise total-digits value facet and minimum-maximum-exclusive-inclusive value facet;
if the total-digits value facet is present, determining the minimum number of bytes required to represent the input data, based on the total-digits value facet;
if the total-digits value facet is not present, determining the minimum number of bytes required to represent the input data, based on the minimum-maximum-exclusive-inclusive value facet;
the message broker system transforming the input data to a physical representation, based on the minimum number of bytes required to represent the input data; and
outputting the transformed input data in the physical representation (122 or 218).

A system, apparatus, or device comprising one of the following items is an example of the invention: message broker, XML data or schema, XML processor, logical or physical representation of data, data type attribute, or any software module, applying the method mentioned above, for purpose of invitation or deriving the minimum number of bytes required to represent numeric data with different physical representations.

Any variations of the above teaching are also intended to be covered by this patent application.

1. A method of deriving the minimum number of bytes required to represent numeric data with different physical representations in a message broker system, said method comprising the steps of:
said message broker system receiving input data and input data type in an extensible markup language in connection with a processor;
wherein said input data type has multiple facets and multiple attributes;
wherein said input data is represented with said input data type;
wherein said input data type comprises twos-complement-integer representation, packed-decimal representation, and extended-decimal representation;
wherein said multiple facets comprise total-digits value facet and minimum-maximum-exclusive-inclusive value facet;
if said total-digits value facet is present, determining said minimum number of bytes required to represent said input data, based on said total-digits value facet;
if said total-digits value facet is not present, determining said minimum number of bytes required to represent said input data, based on said minimum-maximum-exclusive-inclusive value facet;
determining a length for said minimum number of bytes required to represent said input data, based on maximum absolute value of the minimum-maximum values for signed or unsigned integers;
said message broker system transforming said input data to a physical representation, based on said minimum number of bytes required to represent said input data; and
outputting said transformed input data in said physical representation.
